(19) United States
(12) Patent Application Publication
(10) Pub. No.: US 2005/0144477 A1
(43) Pub. Date: Jun. 30, 2005

(54) Apparatus, system, and method for shared access to secure computing resources

(76) Inventors: Charles Douglas Ball, Raleigh, NC (US); Ryan Charles Catherman, Raleigh, NC (US); David Carroll Challener, Raleigh, NC (US); James Patrick Hoff, Raleigh, NC (US); James Peter Ward, Apex, NC (US)

Correspondence Address: KUNZLER & ASSOCIATES, 8 EAST BROADWAY, SUITE 600, SALT LAKE CITY, UT, 84111, US

(21) Appl. No.: 10/748,056

(22) Filed: Dec. 30, 2003

(51) Int. Cl. H04L 9/00

(52) U.S. Cl. 713/201

(57) ABSTRACT

An apparatus, system, and method for shared access to secure computing resources are provided. The apparatus, system, and method include a secure computing module. The secure computing module transacts a secure function for two or more computing modules including an excluding computing module configured to exclusively access the secure computing module. The secure computing module identifies a first computing module transacting the secure function and sets the context of the secure computing module to the first computing module context. The first computing module transacts the secure function, but cannot transact the secure function for a second computing module. The second computing module may also transact the secure function, but may not transact the secure function for the first computing module.

### BACKGROUND OF THE INVENTION

1. Field of the Invention

The invention relates to secure computing and more particularly, to the shared use of a secure computing module.

2. Description of the Related Art

Data processing devices such as computers, servers, personal digital assistants, telephones, routers, and networks frequently manipulate, store, and communicate sensitive data. Sensitive data may include passwords, personal identification numbers, credit card numbers, account numbers, bank routing numbers, client information including names, addresses, email addresses, and telephone numbers, order information, financial data, and communications including voice, text, graphics, and data transmissions.

Secure computing standards groups such as the Trusted Computing Platform Alliance (“TCPA”) and the Trusted Computing Group (“TCG”) have created standards to protect sensitive data in data processing devices. Typically, secure computing standards define protocols and processes for secure functions such as encrypting data, storing cryptographic keys, granting and denying access to data and cryptographic keys, and measuring and tracking the integrity of a secure data processing device. Secure computing standards often assign secure functions to a secure computing module (“SCM”). The SCM may be hardware and software modules that transact secure functions. In one embodiment, data processing device hardware and software modules (“Computing Modules”) such as microprocessors, communications channels, logic circuits, software kernels, operating system software, and software applications transact one or more secure functions with the SCM.

A data processing device may protect sensitive data using a secure computing standard. The data processing device may include a SCM. The SCM transacts secure functions with one or more Computing Modules. The Trusted Computing Group (TCG) has described one embodiment of a secure function as a Trusted Platform Module (“TPM”).

A Computing Module may be an excluding computing module (“ECM”). The ECM is designed to exclusively transact secure functions with the SCM. The ECM requires all other Computing Modules to transact secure functions through the ECM to the SCM. A Computing Module that transacts secure computing functions through the ECM is a conforming computing module (“CCM”).

For example, an ECM may be an operating system. The operating system ECM may only allow one or more CCM to transact secure functions through an operating system ECM application programming interface (“API”). The operating system ECM is designed to exclude all secure function transactions with the SCM by other Computing Modules.

Unfortunately, many Computing Modules, such as legacy services and applications, are not designed to operate through an ECM. Computing Modules that cannot transact secure functions through the ECM are non-conforming computing modules (“NCM”). The NCM may be a legacy Computing Module that was created before the ECM. For example, an NCM created before the design of an ECM API cannot transact secure functions through the ECM API.

A secure data processing device with an ECM transacting secure functions with a SCM cannot also have a NCM transacting secure functions with the SCM. In one embodiment, if the NCM attempts to transact secure functions directly with the SCM, the NCM will be denied access to transact secure functions. In an alternate embodiment, if the NCM transacts secure functions directly with the SCM, the ECM will detect the secure function transactions. The ECM may determine that the security ofthe SCM is compromised and stop secure function transactions with the SCM, preventing the ECM and any CCM from transacting secure functions to protect sensitive data.

A data processing device may include two or more SCM to enable both an ECM and a NCM to transact secure functions. The ECM transacts secure functions with a first SCM. The NCM transacts secure functions with a second SCM. The ECM does not prevent the NCM from transacting secure functions. The NCM secure function transactions also do not cause the ECM to determine that the security of the first SCM is compromised. Both the ECM and the NCM can transact secure functions. Unfortunately, the data processing device requires at least two SCM's to allow both the ECM and the NCM to transact secure functions, increasing the complexity and expense of the data processing device.

What is needed are a method, apparatus, and system that enable both an ECM and a NCM to transact secure functions with a single SCM. What is further needed are a method, apparatus, and system that enable both the ECM and the NCM to transact secure functions on the single SCM without actually compromising the security of the SCM or apparently compromising the security of the SCM. Beneficially, such a process, apparatus, and system would allow both the NCM and the ECM to successfully transact secure functions with the single SCM, reducing the cost of secure computing in the data processing device.

### SUMMARY OF THE INVENTION

The present invention has been developed in response to the present state of the art, and in particular, in response to the problems and needs in the art that have not yet been fully solved by currently available secure computing modules. Accordingly, the present invention has been developed to provide a process, apparatus, and system for enabling an excluding computing module (“ECM”) and a non-conforming computing module (“NCM”) to transact a secure function that overcome many or all of the above-discussed shortcomings in the art.

The apparatus for secure data processing is provided with a logic unit containing a plurality of modules configured to functionally execute the necessary steps of identifying a hardware/software module (“Computing Module”), setting the context of a secure computing module (“SCM”), and transacting a secure function. These modules in the described embodiments include a secure function module (“SFM”), a communication module, and a context module.

The apparatus may be a SCM and transacts a secure function with one or more Computing Modules. The Computing Module may include hardware and software modules such as microprocessors, communications channels, logic circuits, software kernels, operating system software, and software applications. The communication module communicates between the Computing Module transacting the secure function and the SFM. In one embodiment, he Computing Module initiates transacting the secure function with the apparatus. The Computing Module may initiate transacting the secure function by addressing the communication module with electronic signals. The Computing Module may also initiate transacting the secure function by writing software data to the communication module.

The Computing Module may be an ECM. The ECM is designed to exclusively transact the secure function with the apparatus. In addition, the ECM is designed to prevent all other Computing Modules from transacting the secure function with the apparatus except through the ECM. Further, if the ECM detects that any other Computer Module has transacted the secure function with the apparatus, the ECM may determine that the security of the apparatus is compromised. The Computing Module may also be a NCM. The NCM transacts the secure function with the apparatus. The NCM does not transact the secure function through the ECM.

The context module identifies the Computing Module. In one embodiment, the context module receives the identity from the communications module. In an alternate embodiment, the context module receives the identity directly from the Computing Module. The context module sets the context of the SFM to the Computing Module context. For example, the context module may set the context of the SFM to the ECM context. The ECM is enabled to transact the secure function with the SFM as the SFM is in the ECM context.

The ECM does not detect a secure function transaction of a second Computing Module and cannot access the sensitive data of the second Computing Module, such as encrypted data and cryptographic keys. The second Computing Module may be the NCM. Alternately, the context module may set the context of the SFM to the NCM context, enabling the NCM to transact the secure function with the SFM. The NCM also does not detect the secure function transaction ofthe ECM and cannot access the sensitive data of the ECM.

In one embodiment, a Computing Module initiates transacting the secure function with the apparatus and the apparatus completes the secure function transaction each time the secure function transaction is initiated. In an alternate embodiment, the apparatus arbitrates the access of the Computing Module to transact secure functions. For example, the ECM that initiates transacting the secure function with the apparatus maybe denied access to transact the secure function by the apparatus until the apparatus has completed a secure function transaction with the NCM.

A system of the present invention is also presented for secure computing. The system may be embodied in a secure data processing device. In particular, the system, in one embodiment, includes a SCM, an ECM, and a NCM. The ECM and the NCM transact a secure function with the SCM.

The ECM may initiate transacting the secure function with the SCM. The SCM sets the context of the SCM to the ECM context. The ECM transacts the secure function with the SCM in the ECM context. In addition, the NCM may initiate transacting the secure function with the SCM. The SCM sets the context of the SCM to the NCM context and the NCM transacts the secure function with the SCM in the NCM context.

The ECM transacts the secure function with the SCM without detecting the secure function transaction of the NCM and without access to NCM sensitive data. The NCM also transacts secure functions with the SCM without detecting the secure function transaction of the ECM and without access to ECM sensitive data. In one embodiment, either the ECM or the NCM transacts the secure function with the SCM. In an alternate embodiment, the system may enable the NCM to transact the secure function as the ECM transacts the secure function and the ECM to transact the secure function as the NCM transacts the secure function.

A process of the present invention is also presented for secure computing. The process in the disclosed embodiments substantially includes the steps necessary to carry out the functions presented above with respect to the operation of the described apparatus and system. In one embodiment, the process includes identifying the Computing Module, setting the context of the SCM, and transacting the secure function. In addition, the process may include initiating transacting the secure function.

In one embodiment, the process initiates transacting a secure function. The process identifies the Computing Module initiating transacting the secure function and sets the context ofthe SCM to the Computing Module context. In addition, the process transacts the secure function between the Computing Module and the SCM in the Computing Module Context.

The present invention enables an ECM and a NCM to transact a secure function on a single SCM and may reduce the cost of a secure data processing device. In addition, the present invention enables the NCM to transact the secure function with the single SCM that also transacts the secure function with the ECM. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a sensitive data processing device of the present invention;

FIG. 2 is a block diagram illustrating one embodiment of a secure computing module in accordance with the present invention;

FIG. 3 is a block diagram illustrating an alternative embodiment of a secure computing module of the present invention;

FIG. 4a is a block diagram illustrating one embodiment of a cryptographic key table in accordance with the present invention;

FIG. 4b is a block diagram illustrating an alternative embodiment of a cryptographic key table in accordance with the present invention;

FIG. 4c is a block diagram illustrating a further embodiment of a cryptographic key table in accordance with the present invention;

FIG. 5 is a flow chart diagram illustrating one embodiment of a shared access method in accordance with the present invention;

FIG. 6 is a block diagram illustrating one embodiment of a secure computing module of the present invention; and

FIG. 7 is a block diagram illustrating one embodiment of a Computing Module in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

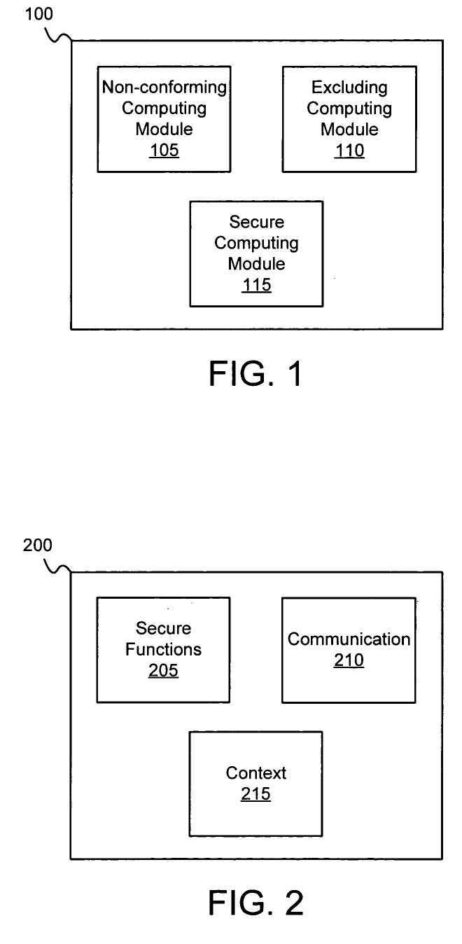

FIG. 1 is a block diagram illustrating one embodiment of a secure data processing device 100 ofthe present invention. The device 100 enables a computing module to transact a secure function. The computing module (“Computing Module”) may include hardware and software modules such as microprocessors, communications channels, logic circuits, software kernels, operating system software, and software applications. The secure data processing device 100 includes a non-conforming computing module (“NCM”) 105, an excluding computing module (“ECM”) 110, and a secure computing module (“SCM”) 115. In addition, the device 100 may include other Computing Modules as are well known to those skilled in the art. Although the secure data processing device 100 is depicted with one NCM 105, one ECM 110, and one SCM, any number of NCMs 105, ECMs 110, and SCMs 115 may be employed.

A Computing Module initiates transacting the secure function with the SCM 115. In one embodiment, the Computing Module is the ECM 110. In an alternate embodiment, the Computing Module is the NCM 105. The SCM 115 identifies the Computing Module and sets the context of the SCM 115 to the Computing Module context. The SCM 115 in the Computing Module context is enabled to transact the secure function with the Computing Module.

For example, the ECM 110 may initiate transacting the secure function with the SCM 115. The SCM 115 identifies the ECM 110. In addition, the SCM 115 sets the context of the SCM 1115 to the ECM 110 context. The ECM 110 transacts the secure function with the SCM 115 as the SCM 115 is in the ECM 110 context, including transacting the secure function with the ECM's 110 sensitive data. In addition, the NCM 105 may initiate transacting the secure function with the SCM 115. The SCM 115 sets the context of the SCM 115 to the NCM 105 context. The NCM 105 transacts the secure function with the SCM 115 as the SCM 115 is in the NCM 105 context. The NCM 105 cannot transact the secure function with the SCM 115 using the ECM's 110 sensitive data. The ECM 110 also cannot transact the secure function with the SCM 115 using the NCM's 105 sensitive data.

In one embodiment, the context of the SCM 115 is either the ECM 110 context or the NCM 105 context. In an alternate embodiment, the context ofthe SCM 115 is the ECM 110 context and the NCM 105 context. The sensitive data processing device 100 supports secure function transactions between Computing Modules and the SCM 115.

FIG. 2 is a block diagram illustrating one embodiment of a SCM 200 in accordance with the present invention. The SCM 200 transacts secure functions with one or more NCM 105 and one or more ECM 110. The SCM 200 includes a secure functions module (“SFM”) 205, a communication module 210, and a context module 215.

The SFM 205 transacts a secure function through the communication module 210. The communication module 210 communicates with one or more Computing Modules. The Computing Module may be an ECM 110. The Computing Module may also be an NCM 105. In one embodiment, the Computing Module initiates transacting the secure function with the SFM 205 through the communication module 210.

The context module 215 identifies the Computing Module initiating the secure function transaction. In one embodiment, the context module 215 is in communication with the Computing Module. In an alternate embodiment, the context module 215 identifies the Computing Module through the communication module 210. The context module 215 sets the context of the SFM 205 to the Computing Module context. The ECM 110 transacts the secure function through the communication module 210 with the SFM 205 as the SFM 205 is in the ECM 110 context. In an alternate embodiment, the NCM 105 initiates transacting the secure function through the communication module 210 with the SFM 205 and the context module 215 sets the context of the SFM 205 to the NCM 105 context. The NCM 105 transacts the secure function through the communication module 210 with the SFM 205 as the SFM 205 is in the NCM 105 context.

The ECM 110 transacts the secure function with the SCM 200 without detecting the secure function transaction of the NCM 105 and without access to NCM 105 sensitive data. The NCM 105 also transacts the secure function with the SCM 200 without detecting the secure function transaction of the ECM 110 and without access to ECM 110 sensitive data. The SCM 200 supports one or more Computing Modules including the ECM 110 transacting the secure function. In a certain embodiment, the SCM 200 is a trusted platform module (“TPM”) as defined by the Trusted Computing Platform Alliance (“TCPA”).

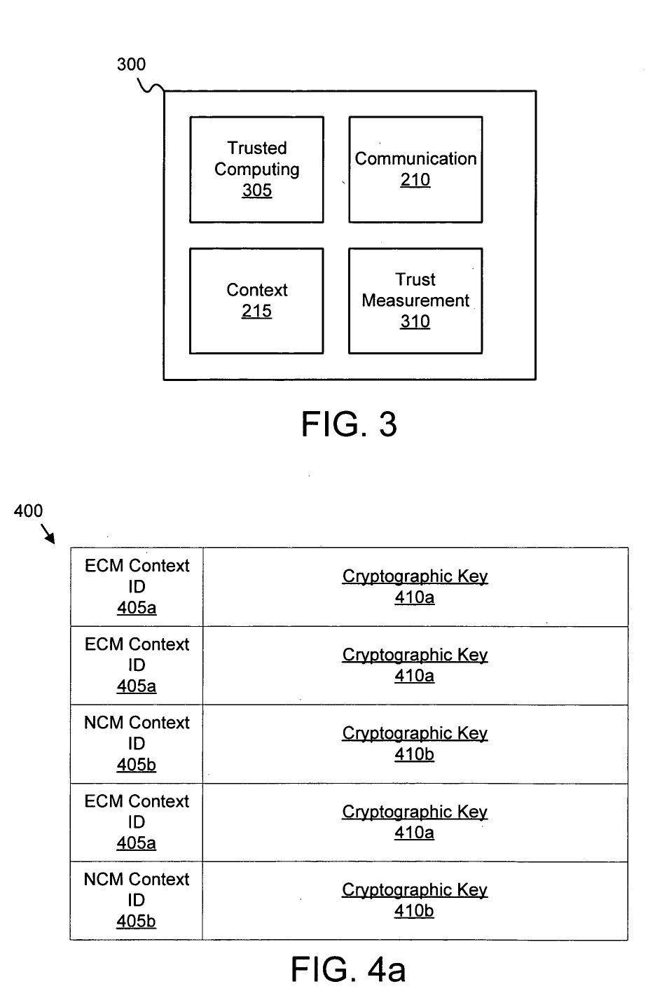

FIG. 3 is a block diagram illustrating one embodiment of a SCM 300 of the present invention. The SCM 300 shows an alternate embodiment for enabling one or more Computing Modules to transact the secure function. The SCM 300 includes a communication module 210, a context module 215, a trusted computing module 305, and a trust measurement module 310. In one embodiment, the trusted computing module 305 and the trust measurement module 310 form the SFM 205 of FIG. 2. In a certain embodiment, the SCM 300 is a trusted building block (“TBB”) as defined by the Trusted Computing Group (“TCG”).

In one embodiment, the trust measurement module 310 gains control of a secure data processing device 100 when the secure data processing device 100 boots. The trust measurement module 310 may control the trusted computing module 305. In one embodiment, the trust measurement module 310 is the Core Root of Trust Measurement as defined by the TCG. In a certain embodiment, the trust measurement module 310 is a binary input/output system (“BIOS”) module.

The Computing Module initiates the secure function transaction with the SCM 300. The context module 215 identifies the Computing Module. In one embodiment, the context module 215 identifies the Computing Module through communication module 210. In an alternate embodiment, the context module 215 communicates directly with the Computing Module to identify the Computing Module. The context module 215 sets the context of the trusted computing module 305 to the Computing Module context. In one embodiment, the trusted computing module 305 transacts the secure function with the Computing Module through the communication module 210. The trusted computing module 305 may be the trusted platform module (“TPM”) as defined by the TCG.

In a certain embodiment, the Computing Module transacts the secure function with the trusted computing module 305 under the control of the trust measure module 310. The Computing Module may be an ECM 110 and may transact the secure function with the trusted computing module 305 in the ECM 110 context. In addition, a NCM 105 may transact the secure function with the trusted computing module 305 in the NCM 105 context. The SCM 300 enables one or more Computing Modules including the ECM 110 and the NCM 105 to transact the secure function.

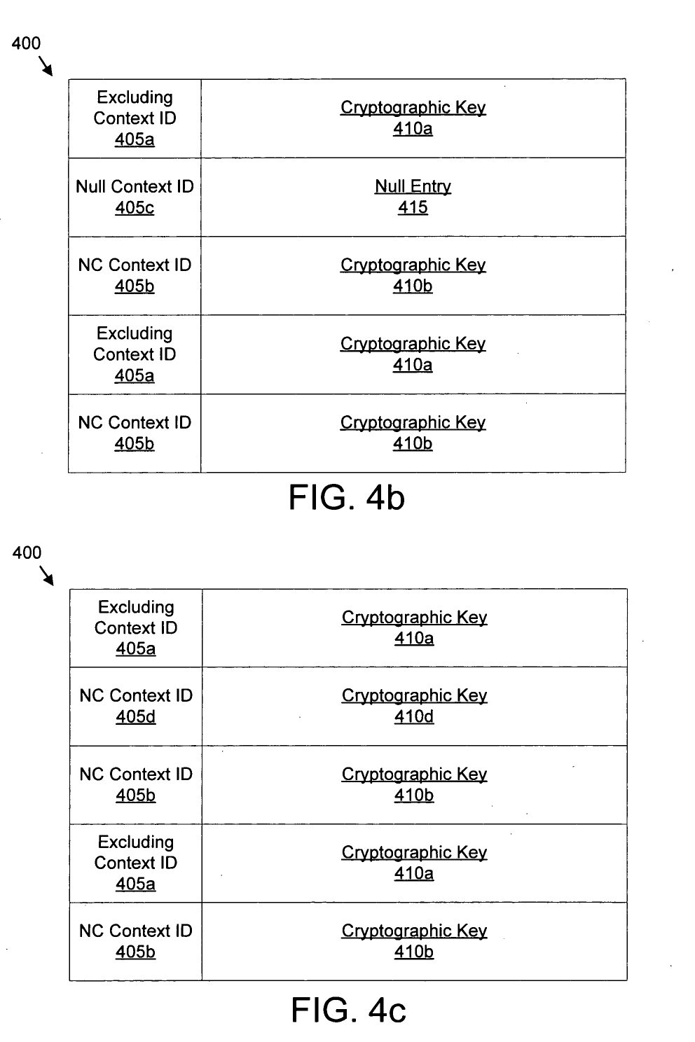

FIG. 4a is a block diagram illustrating one embodiment of a cryptographic key table 400 in accordance with the present invention. The cryptographic key table 400 may store cryptographic keys 410, a secure function that is illustrative of one or more secure functions of the SCM 115. The cryptographic key table 400 includes one or more context identifiers 405 and one or more cryptographic keys 410. Although for simplicity five context identifiers 405 and five cryptographic keys 410 are shown, any number of context identifiers 405 and any number of cryptographic keys 410 may be employed.

In one embodiment, the cryptographic key table 400 stores cryptographic keys 410. In an alternate embodiment, the cryptographic key table 400 stores pointers to cryptographic keys 410. The ECM 110 may transact the secure functions of storing and retrieving the cryptographic key 410a. The ECM context identifier 405a identifies the cryptographic key 410a as having the ECM 110 context. The ECM 110 may store and retrieve the cryptographic key 410a with the ECM 100 context identifier 405a. The NCM 105 may also store and retrieve the cryptographic key 410b. The NCM context identifier 405b identifies the cryptographic key 410b as having the NCM context identifier 405b. The ECM 110 may not store and retrieve the cryptographic key 410b with the NCM 105 context identifier 405b. In addition, the NCM 105 may not store and retrieve the cryptographic key 410a with the ECM 110 context identifier 405a.

FIG. 4b is a block diagram illustrating one embodiment of a cryptographic key table 400 in accordance with the present invention. The cryptographic key table 400 includes a null entry 415. The null context identifier 405c indicates that a cryptographic key 410 may be stored in the null entry 415. In one embodiment, either the ECM 110 or the NCM 105 may store a cryptographic key 410 in the null entry 415.

FIG. 4c is a block diagram illustrating one embodiment of a cryptographic key table 400 in accordance with the present invention. The cryptographic key table 400 illustrates that the NCM 105 has stored a cryptographic key 410d in the null entry 415 of FIG. 4b. In one embodiment, the context identifier 405d indicates that the cryptographic key 410d has the NCM 105 context. The NCM 105 may store and retrieve the cryptographic key 410d. The ECM 110 may not store and retrieve the cryptographic key 410d. The cryptographic key table 400 illustrates the isolation of the sensitive data of the ECM 110 and the NCM 105 in the SCM 115.

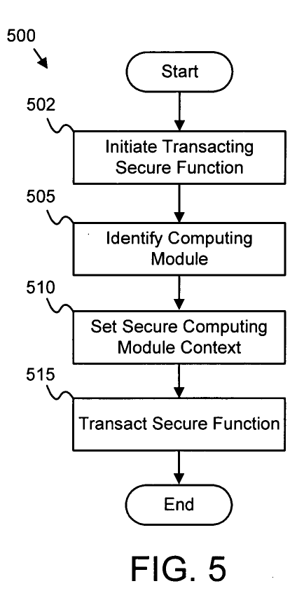

FIG. 5 is a flow chart diagram illustrating one embodiment of a shared access method 500 in accordance with the present invention. The shared access method 500 enables one or more Computing Modules to transact a secure function with a SCM 115. Although for purposes of clarity the shared access method 500 is depicted in a certain sequential order, execution may be conducted in parallel and not necessarily in the depicted order.

In one embodiment, the shared access method 500 initiates 502 transacting a secure function. A Computing Module may initiate 502 transacting the secure function in the shared access method 500. In a certain embodiment, the shared access initiates 502 transacting the secure function by addressing the SCM 115. In one embodiment, the shared access method 500 addresses the SCM 115 with one or more electrical signals. The electrical signals may be the signals of a digital address bus. In an alternate embodiment, the shared access method 500 initiates 502 the secure function transaction by communicating data to the SCM 115.

The shared access method 500 identifies 505 the Computing Module initiating 502 transacting the secure function. In one embodiment, the Computing Module is the ECM 110. In an alternate embodiment, the Computing Module is the NCM 105. The shared access method 500 sets 510 the context of the SCM 115 to the Computing Module context. In one embodiment, the context of the SCM 115 is the ECM 110 context. In an alternate embodiment, the context of the SCM 115 is the NCM 105 context.

The shared access method 500 transacts 515 a secure function between the SCM 115 and the Computing Module that is identified 505 and set 510 as the context of the SCM 115. For example, if the shared access method 500 identifies 505 the NCM 105, the shared access method 500 sets 510 the context of the SCM 115 to the NCM 105 context. The NCM 105 is further enabled to transact 515 the secure function with the SCM 115. The shared access method 500 may also identify 505 the ECM 110, setting 510 the context of the SCM 115 to the ECM 110 context and enabling the ECM 110 to transact 515 the secure function with the SCM 115. The shared access method 500 enables one or more Computing Modules to access the SCM 115.

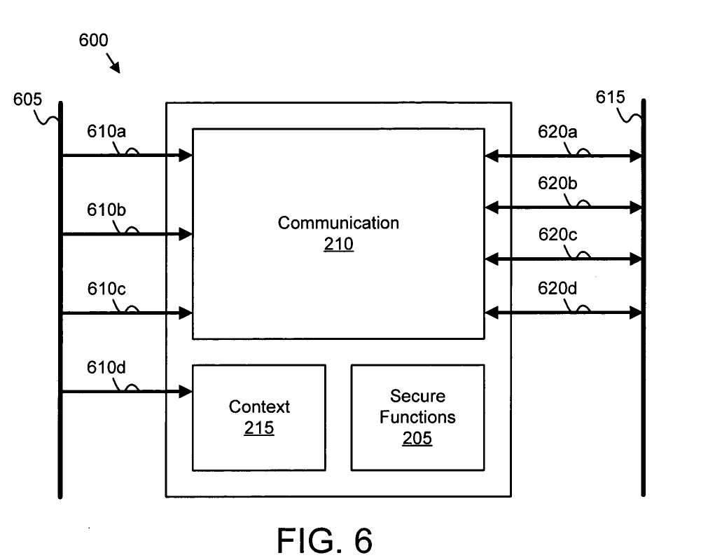

FIG. 6 is a block diagram illustrating one embodiment of a SCM 600 of the present invention. The SCM 600 illustrates initiating a secure function transaction with the SCM 600 using an address bus 605. The SCM 600 includes an address bus 605, one or more address signals 610, a data bus 615, and one or more data signals 620. Although for simplicity one address bus 605, four address signals 610, one data bus 615, and four data signals 620 are shown, any number of address buses 605, address signals 610, data buses 615, and data signals 620 may be employed.

In one embodiment, the address bus 605 is the address bus of a sensitive data processing device 100. One or more address signals 610 may communicate between the address bus 605 and the SCM 600. In one embodiment, the address signal 610 references a secure function such storing the cryptographic key 410 as illustrated in FIG. 4. The SCM 600 may receive the cryptographic key 410 through the data signal 620 to the data bus 615.

In a certain embodiment, each Computing Module addressing the SCM 600 addresses a unique set of addresses. For example, the ECM 110 may address the SCM 600 addresses 0000b through 0111b where address signal 610d is the eights bit. In addition, the NCM 105 may address the SCM 600 addresses 1000b through 1111b. In one embodiment, the address signal 610d communicates with the context module 215. In an alternate embodiment, the address signal 610d communicates with the context module 215 through the communication module 210. The address signal 610d may indicate the Computing Module initiating 502 transacting the secure function with the SCM 600 to the context module 215.

For example, the ECM 110 may initiate 502 transacting the secure function of storing a cryptographic key 410 at the SCM 600 address 0001b. The context module 215 may determine from the address signal 610d that the Computing Module is the ECM 110. The context module 215 may set 510 the context of the SCM 600 to the ECM 110 context. The ECM 110 may transact 515 the secure function with the SCM 600. The SCM 600 employs one or more address signals 610 to indicate the Computing Module initiating the secure transaction with the SCM 600.

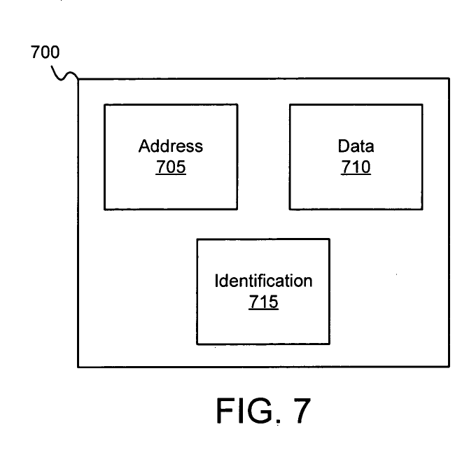

FIG. 7 is a block diagram illustrating one embodiment of a Computing Module 700 in accordance with the present invention. The Computing Module 700 transacts a secure function with a SCM 115. The Computing Module 700 includes an address module 705, a data module 710, and an identification module 715. The Computing Module may also include other hardware and software modules as are well known to those skilled in the art.

In one embodiment, the address module 705 addresses a secure function of the SCM 115. Addressing the secure function may initiate 502 the secure function. The data module 710 communicates sensitive data with the SCM 115. The identification module 715 identifies the Computing Module 700 to the SCM 115.

In one embodiment, the identification module 715 identifies the Computing Module 700 through the address module 705. For example, the identification module 715 may address an address in a specified range of SCM 115 addresses to indicate the identity of the Computing Module 700 to the SCM 115. In an alternate embodiment, the identification module 715 may communicate specified data such as a command through the data module 710 to the SCM 110 to indicate the identity of the Computing Module 700 to the SCM 115. The SCM 115 identifies the Computing Module 700 and sets the context of the SCM 115 to the Computing Module 700 context. The Computing Module 700 transacts the secure function with the SCM 115 in the Computing Module 700 context.

The present invention enables the ECM 110 and the NCM 105 to transact the secure function on the single SCM 115 and may reduce the cost ofthe secure data processing device 100. In addition, the present invention enables the NCM 105 to transact the secure function with the single SCM 115 that also transacts the secure function with the ECM 110. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A secure data processing device, the device comprising:
a secure function module configured receive a computing module context, and to transact a secure function with a computing module in which the secure function module receives the computing module's context;
a communication module configured to communicate with a first computing module, the first computing module configured to exclusively transact the secure function with the secure function module, the communication module further configured to communicate with a second computing module, the second computing module configured to transact the secure function with the secure function module; and
a context module configured to set the context of the secure function module to the first computing module context and, to set the context of the secure function module to the second computing module context.

2. The device of claim 1, wherein context module is configured to set the context of the secure function module to either the first computing module context or the second computing module context.

3. The device of claim 1, wherein context module is configured to set the context of the secure function module to the first computing module context and to the second computing module context.

4. The device of claim 1, wherein context module is configured to arbitrate the setting of the context of the secure function module to the first computing module context and to the second computing module context.

5. The device of claim 1, wherein the context module is configured to set the context of the secure function module responsive to an electrical signal.

6. The device of claim 4, wherein the electrical signal is an address.

7. The device of claim 1, wherein the context module is configured to set the context of the secure function module responsive to data communicated to the communication module.

8. A computing module, the module comprising:
an identification module configured to identify a computing module to a secure computing module, wherein identifying the computing module to the secure computing module sets the context of the secure computing module to the computing module context;
an address module configured to address a secure function of the secure computing module; and
a data module configured to exchange data with the secure computing module.

9. The module of claim 8, the identification module further configured to identify the computing module with an address communicated from the address module.

10. The module of claim 8, the identification module further configured to identify the computing module with data communicated from the data module.

11. A secure data processing system, the system comprising:
a secure computing module configured to identify a computing module responsive to the computing module initiating transacting a secure function with the secure computing module, the secure computing module further configured to set the context of the secure computing module to the computing module context, wherein the secure computing module is configured to transact the secure function with the computing module;
an excluding computing module configured to initiate transacting the secure function with the secure computing module, the excluding computing module further configured to exclusively transact the secure function with the secure computing module; and
a non-conforming computing module configured to initiate transacting the secure function with the secure computing module, the non-conforming computer module further configured to transact the secure function with the secure computing module.

12. The system of claim 11, wherein either the excluding computing module or the non-conforming computing module transacts the secure function with the secure computing module.

13. The system of claim 11, wherein the excluding computing module and the non-conforming computing module transact the secure function with the secure computing module.

14. The system of claim 11, wherein the secure computing module identifies the computing module from an electrical signal.

15. The system of claim 14, wherein the electrical signal is an address.

16. The system of claim 11, wherein the secure computing module identifies the computing module from a data value.

17. A computer readable storage medium comprising computer readable code configured to:
identify a computing module;
set a secure computing module to a computing module context; and
transact a secure function between the secure computing module and the computing module, wherein the transaction is restricted to a secure function and sensitive data of the computing module context.

18. The computer readable storage medium of claim 17, further comprising computer readable code configured to set the context of the secure computing module to an excluding computing module context, wherein an excluding computing module is configured to exclusively transact the secure function with the secure computing module, the computer readable code further configured to set the context of the secure computing module to a non-conforming computing module context, wherein a non-conforming computing module is configured to transact the secure function directly with the secure computing module.

19. The computer readable storage medium of claim 17, further comprising computer readable code configured to identify the computing module as the computing module initiating the secure function transaction.

20. The computer readable storage medium of claim 17, further comprising computer readable code configured to arbitrate the setting of the context of the secure computing module between a first identified computing module and a second identified computing module.

21. The computer readable storage medium of claim 17, further comprising computer readable code configured to identify the computing module responsive to an electrical signal.

22. The computer readable storage medium of claim 17, further comprising computer readable code configured to identify the computing module responsive to an address.

23. The computer readable storage medium of claim 17, further comprising computer readable code configured to identify the computing module responsive to a data value.

24. A secure computing method, the method comprising:
identifying a computing module;
setting a secure computing module to a computing module context; and
transacting a secure function between the secure computing module and the computing module, wherein the transaction is restricted to a secure function and sensitive data of the computing module context.

25. The method of claim 24, further comprising setting the context of the secure computing module to an excluding computing module context, wherein a excluding computing module is configured to exclusively transact the secure function with the secure computing module, the method further comprising setting the context of the secure computing module to a non-conforming computing module context, wherein a non-conforming computing module is configured to transact the secure function directly with the secure computing module.

26. The method of claim 24, further comprising initiating the transacting of the secure function.

27. The method of claim 24, further comprising arbitrating the setting of the secure computing module context between a first computing module and a second computing module.

28. The method of claim 24, wherein the computing module is identified from an electrical signal.

29. The method of claim 24, wherein the computing module is identified from a data value.

30. An apparatus for secure computing, the apparatus comprising:
means for identifying a computing module;
means for setting a secure computing module to a computing module context; and
means for transacting a secure function between the secure computing module and the computing module, wherein the transaction is restricted to a secure function and sensitive data of the computing module context.
